(19) United States
(12) Patent Application Publication
(10) Pub. No.: US 2007/0125693 A1
(43) Pub. Date: Jun. 7, 2007

(54) Filter presses

(76) Inventor: Mark Christopher Lindley, Staffordshire (GB)

Correspondence Address: SMITH-HILL AND BEDELL, P.C., 16100 NW CORNELL ROAD, SUITE 220, BEAVERTON, OR, 97006, US

(21) Appl. No.: 10/579,956

(22) PCT Filed: Nov. 18, 2004
(86) PCT No.: PCT/GB04/04870

§ 371 Date: Feb. 20, 2007

(30) Foreign Application Priority Data
Nov. 20, 2003 (GB) 0326988.3

(51) Int. Cl. B01D 25/00

(52) U.S. Cl. 210/224; 210/231; 210/780

(57) ABSTRACT

A filter plate press with a plurality of filter plates. A resilient diaphragm is provided on one side only of each filter plate and hot water or steam can be passed between the diaphragm and the adjacent filter plate. Each filter plate has a steel core to provide high heat transfer, such that heated fluid between a diaphragm and a respective plate heats the filter chamber on the opposite side of the respective filter plate.

This invention relates to plates for filter plate presses, filter plate presses and also a method of filtration using a filter plate press.

A filter plate press comprises a plurality of movable plates which, when pressed together, define a number of chambers into which material to be filtered can be fed. Each chamber has filtration means therein so that residue is retained within the chamber and filtrate is removed therefrom. The residue forms a filter cake and by various known means the moisture content of the cake can be reduced. When the filtration process is completed the plates are separated so that filter cake can be removed from the chambers. After cleaning and rearranging of the plates a further filtration operation can be carried out.

Once an initial filtration has been achieved by apparatus of this nature, to increase the efficiency of filtration it is necessary to employ one or more of a number of additional stages, one such stage involves applying pressure to the filter cake by lining the chamber on each side with resilient diaphragms which can be forced into the chamber by applying pressure therebehind to reduce the chamber volume and thereby exert a further filtration pressure on the filter cake. It has found to be advantageous by applying pressure to the resilient diaphragms using a heated fluid whereby to also heat the filter cake in the respective filter chamber.

According to the present invention there is provided a filter plate press with a plurality of filter plates, a resilient diaphragm being provided attached to one side only of each plate, along with means for supplying fluid at an elevated temperature between each diaphragm and the respective plate whereby to apply heat to the filter cake in the filter chambers on either side of the plate, each plate including at least a part thereof which defines, or is adjacent with, in use, the filter chamber, of a transfer material with a high thermal conductivity, such that in use heat is transferred from the elevated temperature fluid through the transfer material to the filter chamber on the opposite side of the plate.

The transfer material may be steel.

The transfer material may be provided as a core of the filter plate, with a covering thereon of a different material. The covering may be of rubber.

The invention further provides a method of filtration using a filter plate press according to any of the above three paragraphs, the method including supplying heated fluid between the diaphragms and respective plates to apply heat and pressure to the filter cake in the respective filter chamber, and also to supply heat to the filter chamber on the opposite side of the filter plate.

The heated fluid may be hot water or steam. The heated fluid is preferably continuously recirculated during use, and may be reheated as required to maintain temperature.

An embodiment of the present invention will now be described by way of example only and with reference to the accompanying drawings, in which:

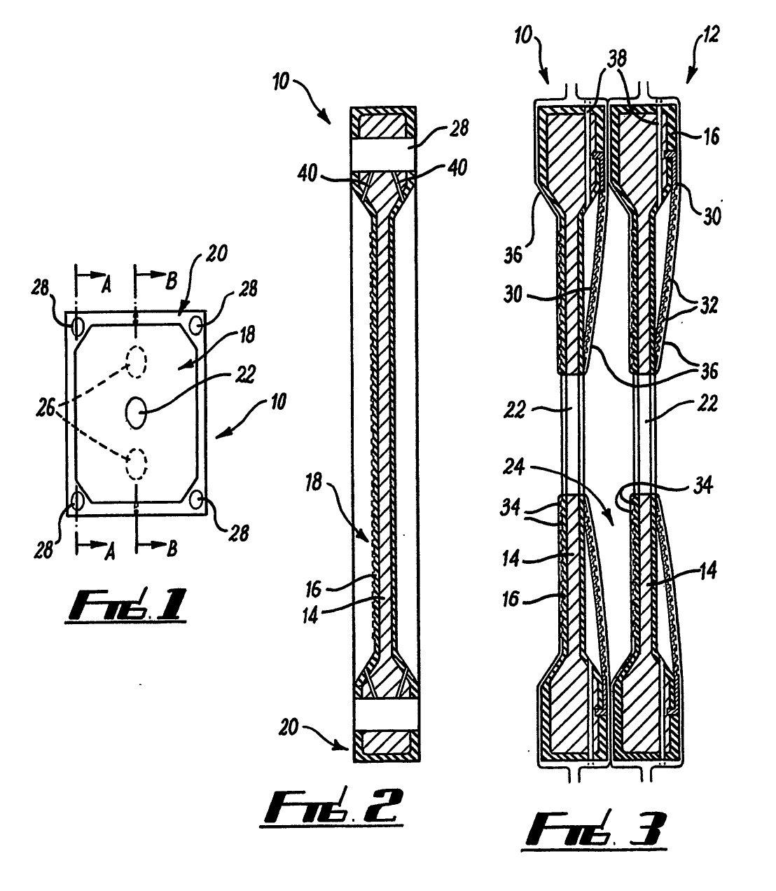

FIG. 1 is a diagrammatic plan view of a filter press plate according to the invention;

FIG. 2 is a diagrammatic sectional view along the line A-A of FIG. 1; and

FIG. 3 is a diagrammatic sectional view along the line B-B of FIG. 1 showing two plates in a filter press according to the invention.

The drawings show a filter plate 10 of a filter plate press, with FIG. 3 showing an adjacent filter plate 12. Each of the plates 10, 12 have a steel core 14 with a moulded rubber coating 16. A generally rectangular central portion 18 is provided with an increased thickness peripheral portion 20 which also extends over the corners of the central portion 18. The thicknesses of the plates 10, 12 in the drawings has been enhanced for clarity.

Each of the filter plates 10, 12 are mounted on a framework (not shown) and can be separated from each other to permit removal of filter cake, but during filtration are clamped together. A supply port 22 is provided centrally of each of the plates 10, 12 for supplying fluid to be filtered into the filter chambers 24 defined between the plates 10, 12. FIG. 1 indicates two alternative locations of the supply ports at 26, and in some arrangements fluid can be supplied through one or more corner ports 28 as shown in FIG. 1.

A detachable resilient polymeric diaphragm 30 is provided on one side only of each filter plate 10, 12. A plurality of protrusions 32 are provided on the external face of the diaphragm 30. A plurality of protrusions 34 are also provided on the side of the filter plates 10, 12 which do not carry the diaphragm 30. A filter cloth 36 is provided around each of the plates 10, 12.

Passages 38 extend through the peripheral portions 20 to permit fluid to be supplied between the plates 10, 12 and the diaphragms 30. Passages 40 also extend through the peripheral portion 20 from the corner ports 28.

In use, fluid to be filtered is supplied through the supply port 22 into the chambers 24 where primary filtration takes place through the filter cloth 30 leaving the filter cake within the chamber 24 with the filtrate being removed through the branches 40 leading to the corner ports 28.

Filtration is enhanced by applying a source of heat under pressure, such as hot water or steam through the passages 38 to behind the diaphragms 30. This causes the diaphragms 30 to move into the chambers 24 compressing the filter cake therein and also heating the filter cake. The provision of the steel core 14 means that the heated fluid on one side of the filter plates 10, 12 not only heats the filter cake on that side of the filter cake 10, 12, but because of the high thermal conductivity of the steel core 14 heating of the filter cake on the opposite side of the filter plates 10, 12 also takes place. The hot water or steam is continually re-circulated from a stock tank where it can be heated to maintain it at a required temperature. Pressure within the filter cake can also be reduced to further enhance the filtration.

There is thus described a filter plate press, a plate for such a press and also a method of filtration which provide advantageous features. The steel core of the filter plates enables the provision on one side only of the resilient diaphragms, whilst permitting heating of the filter cake on either side of the filter plates. This can provide a considerable cost saving relative to conventional arrangements where it has been necessary to provide diaphragms on each side of each filter plate The steel core also provides reinforcement for the filter plates to permit large plates to be made without staybosses.

It is to be realised that various modifications may be made without departing from the scope of the invention.

Whilst endeavourina in the foreaoina specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-11. (canceled)

12. A filter plate press with a plurality of filter plates, a resilient diaphragm being provided attached to one side only of each plate, along with means for supplying fluid at an elevated temperature between each diaphragm and the respective plate whereby to apply heat to the filter cake in the filter chambers on either side of the plate, each plate including at least a part thereof which defines, or is adjacent with, in use, the filter chamber, of a transfer material with a high thermal conductivity, such that in use heat is transferred from the elevated temperature fluid through the transfer material to the filter chamber on the opposite side of the plate.

13. A press according to claim 12, wherein the transfer material is steel.

14. A press according to claim 12, wherein the transfer material is provided as a core of the filter plate, with a covering thereon of a different material.

15. A press according to claim 14, wherein the covering is of rubber.

16. A method of filtration using a filter plate press according to claim 12, the method including supplying heated fluid between the diaphragms and respective plates to apply heat and pressure to the filter cake in the respective filter chamber, and also to supply heat to the filter chamber on the opposite side of the filter plate.

17. A method according to claim 16, wherein the heated fluid is hot water or steam.

18. A method according to claim 16, wherein the heated fluid is continuously recirculated during use.

19. A method according to claim 18, wherein the heated fluid is continuously recirculated during use.
